(19) United States
(12) Patent Application Publication
(10) Pub. No.: US 2007/0285354 A1
(43) Pub. Date: Dec. 13, 2007

(54) PLASMA DISPLAY PANEL AND MANUFACTURING METHOD OF THE SAME

(76) Inventors: Jae-Rok Kim, Yongin-si (KR); Min Hur, Yongin-si (KR)

Correspondence Address: CHRISTIE, PARKER & HALE, LLP, PO BOX 7068, PASADENA, CA, 91109-7068, US

(21) Appl. No.: 11/737,628

(22) Filed: Apr. 19, 2007

(30) Foreign Application Priority Data
May 12, 2006 (KR) 10-2006-0042896

(51) Int. Cl. G09G 3/28

(52) U.S. Cl. 345/60

(57) ABSTRACT

A plasma display panel has a dielectric layer with a relatively high dielectric withstanding voltage that can be easily formed, and a manufacturing method thereof. The plasma display panel includes a first substrate; a second substrate facing the first substrate; a plurality of first electrodes disposed along a first direction between the first substrate and the second substrate; a plurality of second electrodes disposed apart from the first electrodes between the first substrate and the second substrate, and extending along a second direction crossing the first direction; a plurality of third electrodes disposed apart from the first electrodes between the first substrate and the second substrate, and extending along the second direction; and a plurality of oxide dielectric layers disposed on the first electrodes, the second electrodes, or the third electrodes, the oxide dielectric layers comprising oxidized materials of the first electrodes, the second electrodes, or the third electrodes.

### CROSS-REFERENCE TO RELATED APPLICATION

This application claims priority to and the benefit of Korean Patent Application No. 10-2006-0042896, filed in the Korean Intellectual Property Office on May 12, 2006, the entire content of which is incorporated herein by reference.

### BACKGROUND OF THE INVENTION

(a) Field of the Invention

The present invention relates to a plasma display panel and a manufacturing method thereof.

(b) Description of the Related Art

Plasma display panels (PDPs) display an image by using visible light generated when vacuum ultraviolet rays radiating from plasma generated by a gas discharge excite a phosphor material. The PDPs enable relatively large size display screens (e.g., can be bigger than 60 inches) that are relatively thin (e.g., can be thinner than 10 cm). In addition, the PDPs have excellent color reproduction characteristics and large viewing angles. The PDPs have relatively greater productivity and lower cost due to a simpler method of manufacturing than that of LCDs, and have generated much attention as a next generation industrial flat panel display and/or home TV display.

A three-electrode surface-discharge type PDP has been developed. The three-electrode surface-discharge type PDP includes one substrate that has two electrodes arranged on the same surface extending along a first direction, and another substrate that is arranged a certain distance therefrom and includes address electrodes extending in a second direction perpendicular to first direction. The space between the pair of substrates is filled with a discharge gas, and the substrates are sealed with each other.

Generally, whether or not the discharge occurs is determined by the discharge of scan electrodes that are connected to each line and independently controlled, and address electrodes facing the scan electrodes. In addition, sustain discharge that displays brightness of an image is generated by two electrode groups, namely sustain electrodes and scan electrodes, that are located on the same surface.

However, in the three-electrode surface-discharge type PDPs, as the gap between address electrodes and scan electrodes is narrowed, the discharge efficiency decreases. That is, a cathode sheath around the cathode, an anode sheath around the anode, and a positive column between the two sheaths are formed during a sustain discharge, and the positive column related to discharge efficiency is formed to be relatively short in the three-electrode surface-discharge type PDP.

Therefore, a PDP with an opposed discharge structure and that is capable of forming a longer positive column has been developed. However, in this type of PDP, many process steps are required to form a dielectric layer on the outer surface of address electrodes and scan electrodes. For example, the steps may include forming electrodes, covering the electrodes, and printing a dielectric layer all over the substrate, forming a mask on the dielectric layer, patterning the mask, and forming dielectric patterns through exposure and development. In addition, the surface of the electrode dielectric layer formed through the many process steps is relatively rough. When the surface of electrode dielectric layer is formed to be relatively rough, the distribution of wall charges accumulated on the dielectric layer becomes uneven and the voltage margin deteriorates due to a strong electric field created partially around the protrusions.

### SUMMARY OF THE INVENTION

Aspects of embodiments of the present invention are directed to a plasma display panel having a dielectric layer with a high dielectric withstanding voltage that can be formed easily, and manufacturing method thereof.

Aspects of embodiments of the present invention are directed to a plasma display panel and a manufacturing method thereof in which a dielectric layer with a fine surface as well as a high dielectric withstanding voltage can be formed easily.

According to an embodiment of the invention, a plasma display panel is provided. The plasma display panel includes a first substrate; a second substrate facing the first substrate; a plurality of first electrodes disposed along a first direction between the first substrate and the second substrate; a plurality of second electrodes disposed apart from the first electrodes between the first substrate and the second substrate, and extending along a second direction crossing the first direction; a plurality of third electrodes disposed apart from the first electrodes between the first substrate and the second substrate, and extending along the second direction; and a plurality of oxide dielectric layers disposed on the first electrodes, the second electrodes, or the third electrodes. Here, the oxide dielectric layers include oxidized materials of the first electrodes, the second electrodes, or the third electrodes.

In one embodiment, the materials of the first electrodes, the second electrodes, or the third electrodes include aluminum, and the oxide dielectric layers include aluminum oxide.

In one embodiment, the second electrodes and the third electrodes protrude along a direction away from the second substrate and face each other with a space therebetween.

In one embodiment, the plasma display panel further includes a plurality of barrier ribs for defining a plurality of discharge cells between the first substrate and the second substrate. Here, the second electrodes and the third electrodes are located on boundaries of the discharge cells adjacent to each other along the first direction, and are arranged alternately along the first direction.

In one embodiment, the plasma display panel further includes a plurality of barrier ribs for defining a plurality of discharge cells between the first substrate and the second substrate. Here, a plurality of recesses are disposed on boundaries of the discharge cells adjacent to each other along the first direction, the recesses communicate with one another along the second direction, and the second electrodes and the third electrodes are inserted into the recesses.

In one embodiment, the barrier ribs include a plurality of first barrier rib members extending along the first direction; and a plurality of second barrier rib members extending along the second direction. Here, the recesses are formed at intersections of the first barrier rib members and the second barrier rib members.

In one embodiment, the barrier ribs include a plurality of first barrier rib members extending along the first direction; and a plurality of second barrier rib members extending along the second direction. Here, a height of the first barrier rib members measured along a direction perpendicular to the first substrate is higher than a height of the second barrier rib members.

In one embodiment, the oxide dielectric layers extend along the second direction.

In one embodiment, a width of the oxide dielectric layers measured along the first direction is not greater than a width of the recesses.

In one embodiment, a height of the oxide dielectric layer measured along a direction perpendicular to the second substrate is substantially equal to a height of the recesses.

In one embodiment, the first electrodes are disposed on the second substrate, and are located on boundaries of the discharge cells adjacent to each other along the second direction.

In one embodiment, the first electrodes include a plurality of bus electrodes and a plurality of protrusion electrodes, and wherein the bus electrodes are located on boundaries of the discharge cells adjacent to each other along the second direction.

In one embodiment, one of the protrusion electrodes corresponds to one of the discharge cells and protrudes from one of the bus electrodes toward the center of the one of the discharge cells.

According to another embodiment of the invention, a plasma display panel is provided. The plasma display panel includes a first substrate; a second substrate facing the first substrate; an address electrode disposed along a first direction between the first substrate and the second substrate; a sustain electrode disposed apart from the address electrode between the first substrate and the second substrate, and extending along a second direction crossing the first direction; a scan electrode disposed apart from the first electrodes between the first substrate and the second substrate, and extending along the second direction; and an oxide dielectric layer disposed on the address electrode, the sustain electrode, or the scan electrode, the oxide dielectric layer comprising an oxidized material of the address electrode, the sustain electrode, or the scan electrode.

According to another embodiment of the invention a method of manufacturing a plasma display panel is provided. The method includes: forming electrodes between a pair of substrates; and anodizing the electrodes to form a plurality of oxide dielectric layers comprising oxides of materials of the electrodes on the electrodes.

In one embodiment, the forming of the electrodes includes patterning aluminum to form the electrodes, and the forming of the oxide dielectric layers includes anodizing the aluminum to form the oxide dielectric layers including aluminum oxides.

In one embodiment, the forming of the electrodes includes: patterning a non-aluminous material to form the electrodes; and covering the non-aluminous metal with aluminum.

In one embodiment, the forming of the oxide dielectric layers includes anodizing the aluminum to form the oxide dielectric layers including aluminum oxides on a surface of the non-aluminous metal.

In one embodiment, the non-aluminous metal includes silver, copper, or gold.

In one embodiment, the method further includes: forming barrier ribs for defining a plurality of discharge cells between the pair of substrates; forming recesses on the barrier ribs, the recesses being boundaries of the discharge cells adjacent to each other along a first direction, the recesses communicating with one another along a second direction crossing the first direction; and inserting the electrodes into the recesses, the electrodes having the oxide dielectric layers formed on surfaces thereof.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partial exploded perspective view showing a plasma display panel (PDP) according to a first embodiment of the present invention.

FIG. 2 is a partial plan view schematically showing a structure of electrodes and discharge cells of the plasma display panel according to the first embodiment of the present invention.

FIG. 3 is a partial cross-sectional view taken along line III-III of FIG. 1.

FIG. 4 is a cross-sectional view showing a method of forming electrodes of the plasma display panel according to the first embodiment of the present invention.

FIG. 5 is a schematic diagram showing an anodizing process of the plasma display panel according to the first embodiment of the present invention.

FIG. 6 is a cross-sectional view showing a method of forming oxide dielectric layers of the plasma display panel according to the first embodiment of the present invention.

FIG. 7 is a cross-sectional view showing a method of forming electrodes of a plasma display panel according to a second embodiment of the present invention.

FIG. 8 is a cross-sectional view showing a method of forming oxide dielectric layers of the plasma display panel according to the second embodiment of the present invention.

### DETAILED DESCRIPTION

The accompanying drawings, together with the specification, illustrate exemplary embodiments of the present invention, and, together with the description, serve to explain the principles of the present invention.

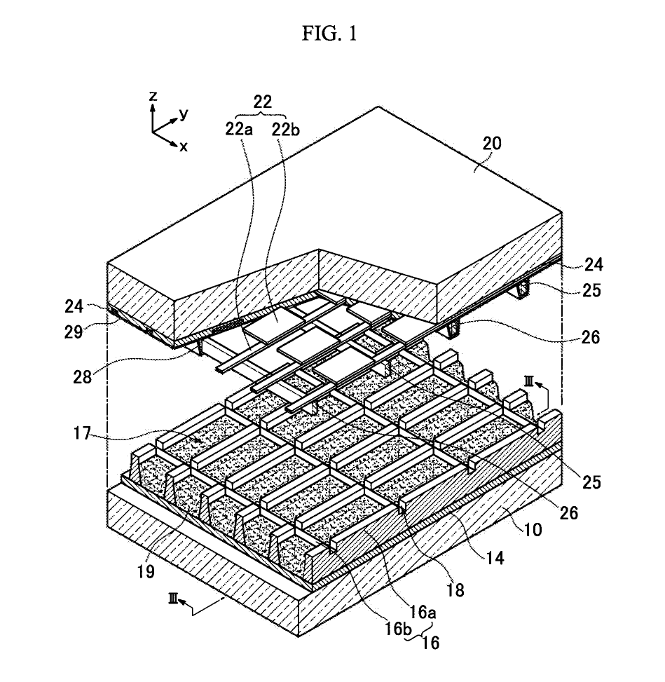

Referring to FIG. 1, a plasma display panel (PDP) according to a first embodiment of the present invention includes a first substrate (hereinafter also referred to as a rear substrate) and a second substrate (hereinafter also referred to as a front substrate) facing each other with a certain distance therebetween. A plurality of discharge cells 17 are partitioned between the rear substrate 10 and the front substrate 20. Phosphor layers 19 are formed within the discharge cells 17, and they absorb ultraviolet rays and radiate visible light. The discharge cells 17 are filled with a discharge gas (for example, a gas mixture including xenon (Xe), neon (Ne), etc.).

A first dielectric layer 14 (hereinafter also referred to as a rear dielectric layer) is formed on the surface of the rear substrate 10 facing the front substrate 20, and barrier ribs 16 for partitioning the plurality of discharge cells 17 are formed on the rear dielectric layer 14. Although the barrier ribs 16 are shown to be formed on the rear dielectric layer 14 in the present embodiment, the present invention is not thereby limited. For example, the barrier ribs 16 may be formed on the rear substrate 10 without forming the rear dielectric layer 14. In addition, the barrier ribs 16 may be formed by etching the rear substrate 10 into a shape corresponding to the discharge cell 17. In this case, the barrier ribs 16 and the rear substrate 10 are made of the same material.

The barrier ribs 16 include first barrier rib members 16a and the second barrier rib members 16b. The first barrier rib members 16a extend along a first direction (e.g., along a y-axis direction in FIG. 1), and the second barrier rib members 16b extend along a second direction (e.g., along an x-axis direction in FIG. 1) intersecting the first direction. The discharge cells 17 are partitioned by the first barrier rib members 16a and the second barrier rib members 16b.

Recesses 18 are formed on the first barrier rib members 16a on the boundaries of the discharge cells 17 adjacent to each other along the first direction, and the recesses 18 communicate with one another along the second direction. More specifically, the recesses 18 are formed at the intersections of the first barrier rib members 16a and the second barrier rib members 16b, and the height of the first barrier rib members 16a measured along a direction perpendicular to the rear substrate 10 is higher than the height of the second barrier rib members 16b. Thus, for one discharge cell 17, the first barrier rib members 16a that are higher than the second barrier rib members 16b formed on either of the second directional sides of the discharge cell 17 are formed on either of the first directional sides of the discharge cell 17. The recesses 18 are formed on the boundaries of the discharge cells 17 adjacent to each other along the first direction, and communicate with one another along the second direction.

The structure of the barrier ribs of the present invention is not limited to the above described structure. For example, a stripe-type barrier rib structure including barrier rib members parallel only to the first direction may be applied to the present invention. A structure of barrier ribs having recesses on the first barrier rib members parallel to the first direction can be applied to the present invention and also belong to the scope of the present invention.

First electrodes 22 (hereinafter also referred to as address electrodes) extend along the first direction on the surface of the front substrate 20 facing the rear substrate 10. The address electrode 22 are arranged parallel to and spaced apart from each other. A second dielectric layer 24 (hereinafter also referred to as front dielectric layer) is formed on the front substrate 20 and covers the address electrodes 22. Second electrodes 25 (hereinafter also referred to as sustain electrodes) and third electrodes 26 (hereinafter also referred to as scan electrodes) are formed on the front dielectric layer 24 and extend along the second direction.

A third dielectric layer 28 (hereinafter also referred to as oxide dielectric layer) is formed on the front dielectric layer 24 and covers the sustain electrodes 25 and the scan electrodes 26. The oxide dielectric layer 28 corresponds to the second barrier rib members 16b and extends along the second direction.

In the present embodiment, electrode materials for the sustain electrodes 25 and the scan electrodes 26 are oxidized to form the oxide dielectric layer 28 on the sustain electrodes 25 and the scan electrodes 26. Specifically, the sustain electrodes 25 and the scan electrodes 26 are made of aluminum (Al), and the aluminum is anodized to form the oxide dielectric layer 28 including aluminum oxide (Al₂O₃). In the present embodiment, the sustain electrodes 25 and the scan electrodes 26 are anodized to form the oxide dielectric layer on the surface thereof, but the present invention is not limited thereto. The oxide dielectric layer can also be formed on the surface of the address electrodes 22 through anodizing, and still belong to the present invention. In the present embodiment as shown in FIG. 1, the oxide dielectric layer 28 is formed directly on the surfaces of the sustain electrodes 25 and the scan electrodes 26, and extends along the second direction in which the sustain electrodes 25 and the scan electrodes 26 extend.

As described above, the oxide dielectric layer 28 is formed on the front substrate 20 along the second direction, and the recesses 18 are formed on the first barrier rib members 16a and communicate with one another. Thus, a plasma display panel, which has a structure of opposed discharge having barrier ribs of a matrix structure with the first barrier rib members 16a and the second barrier rib members 16b intersecting, and which has the electrodes formed on the front substrate and the recesses formed on the rear substrate, can be realized.

A protective layer 29 may be formed on the outer surface of the front dielectric layer 24 and the oxide dielectric layer 28. In one embodiment, the protective layer 29 is formed on the surface that is exposed to gas discharge. An example of the protective layer 29 may be a MgO protective layer 29. The MgO protective layer 29 protects dielectric layers and dielectric materials against collisions with ions dissociated during the gas discharge. The MgO protective layer 29 may improve the efficiency of discharge due to its high secondary electron emission factor when colliding with the ions.

The phosphor layer 19 is formed within the discharge cell 17. More specifically, the phosphor layer 19 is formed on the side surfaces of the barrier ribs 16 and the rear dielectric layer 14 that are formed on the rear substrate 10, and the phosphor layer 19 may be made of a reflective phosphor. As described above, the present embodiment can reduce (or prevent) uneven discharge firing voltage due to different permittivities between red, green, and blue phosphor layers that are caused by the address electrodes 22 formed on the front substrate 20 and the phosphor layers 19 formed on the rear substrate 10.

Here, in the present embodiment, because the address discharge occurs on the address electrodes 22 on the front substrate 20 and the scan electrodes 26 on the rear substrate 10, electric charges do not accumulate on the phosphor layer 19 on the rear substrate during address discharge. Therefore, the durability loss of phosphor by ion sputtering of the accumulated charges on the phosphor layer 19 may be prevented (or reduced).

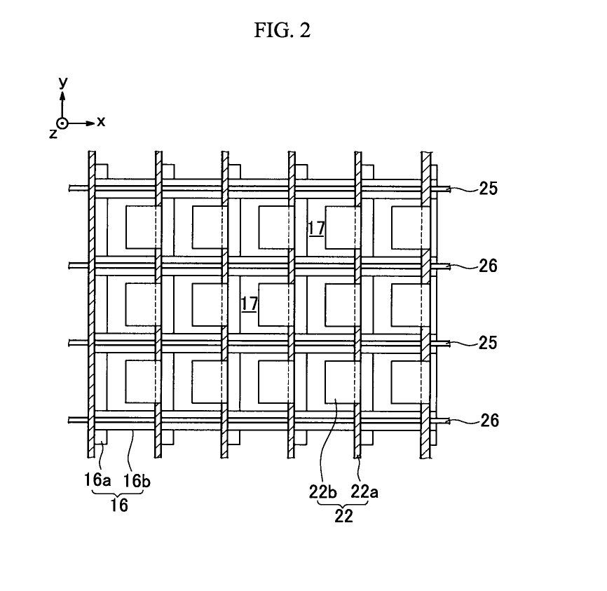

Referring to FIG. 2, the address electrodes 22 extend along a first direction (e.g., along a y-axis direction in FIG. 2) and include bus electrodes 22a and protrusion electrodes 22b. The bus electrodes 22a correspond to the first barrier rib members 16a and extend along the first direction. Each of the protrusion electrodes 22b corresponds to a corresponding discharge cell 17 and protrudes from a corresponding one of the bus electrodes 22a toward the center of the corresponding discharge cell 17.

In this case, the protrusion electrodes 22b may be transparent electrodes, for example ITO (indium tin oxide) electrodes, for ensuring an adequate aperture ratio for the front substrate 20. Although protrusion electrodes 22b are shown to be in the shape of rectangles in the present embodiment, protrusion electrodes in other shapes may also be applied to the present embodiment. For example, protrusion electrodes in a triangular shape gradually decreasing in size along a direction from the scan electrodes 26 toward the sustain electrodes 25 may be applied to the present embodiment and belong to the scope of the present invention. The bus electrodes 22a may be made of metal so as to ensure high conductivity by compensating for high electrical resistance of the transparent electrodes. In the present embodiment, the bus electrodes 22a are located on the boundaries of the discharge cells 17 adjacent to each other along a second direction (e.g., along an x-axis direction in FIG. 2). Thus, the present embodiment has the advantage that the aperture ratio for the front substrate 20 does not decrease, even though the bus electrodes 22a are made of metal.

The sustain electrodes 25 and the scan electrodes 26 are formed along the second direction intersecting the first direction of (or crossing) the address electrodes 22. In the present embodiment, the sustain electrodes 25 and the scan electrodes 26 are located on the boundaries of discharge cells 17 adjacent to each other along the first direction, and are arranged alternately along the first direction. The scan electrodes 26 enable address discharge by interacting with the address electrodes 22 during an addressing period. The discharge cells 17 to be turned on are selected by the address discharge. The sustain electrodes 25 enable sustain discharge by interacting mainly with the scan electrodes 26 during a sustain period. Images are displayed through the front substrate 20 by the sustain discharge. However, the role of each electrode varies with the kind of voltage supplied to the electrode, and is not limited to the above described embodiments.

The sustain electrodes 25 and the scan electrodes 26 also are formed of metal. In other words, in the present embodiment, the sustain electrodes 25 and the scan electrodes 26 are located on the boundaries of discharge cells adjacent to each other along the first direction, so that the aperture ratio does not decrease even if the electrodes are made of metal.

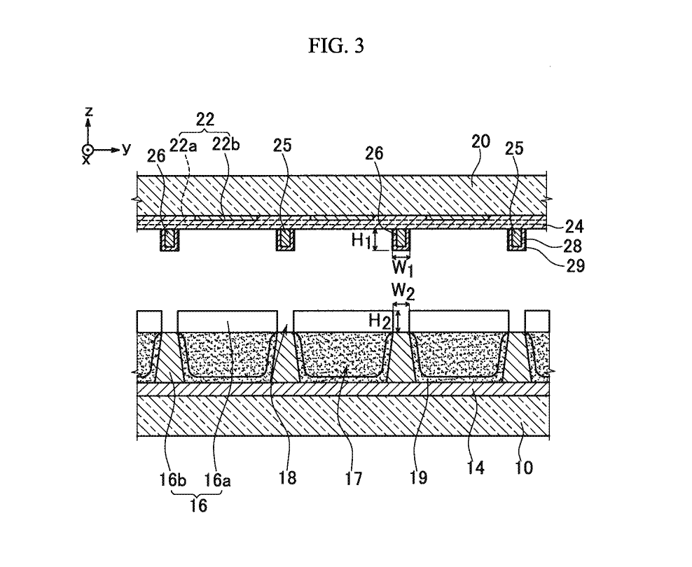

Referring to FIG. 3, the sustain electrodes 25 and the scan electrodes 26 are formed on the front dielectric layer 24 to cover the address electrodes 22. The sustain electrodes 25 and the scan electrodes 26 protrude along a direction away from the front substrate 20, and face each other with a space therebetween. The cross-sections of the sustain electrodes 25 and the scan electrodes 26 may be formed to have a dimension along a direction perpendicular to the substrates 10 and 20 (e.g., along a z-axis direction) longer than a dimension along a direction parallel to the substrates 10 and 20 (e.g., a y-axis direction). In other words, the height of the sustain electrodes 25 and the scan electrodes 26 measured from the surface of the front substrate 20 may be greater than their width. By heightening (or increasing the height of) the sustain electrodes 25 and the scan electrodes 25, even if the size of the discharge cell along a planar direction is diminished, the decrement of size can be compensated for. Furthermore, by enlarging the surface of the sustain electrodes 25 and the scan electrodes 26 facing each other, the efficiency of luminescence may be higher than the efficiency of luminescence of the surface discharge PDP.

The oxide dielectric layer 28 is formed on the surface of the sustain electrodes 25 and the scan electrodes 26. The oxide dielectric layer 28 and the front dielectric layer 24 covering the address electrodes 22 may be made of the same material, thus protecting each electrode against collision with ions generated during a gas discharge. Wall charges may accumulate on the front dielectric layer 24 and the oxide dielectric layer 28, thus lowering the discharge firing voltage during a sustain discharge between the sustain electrodes 25 and the scan electrodes 26.

A width (W1) of the oxide dielectric layer 28 measured along the first direction (the y-axis direction) is equal to or narrower than a width (W2) of the recess 18 that is formed on the first barrier rib member 16a. As described above, because the width (W1) of the oxide dielectric layer 28 is equal to or narrower than the width (W2) of the recess 18, the address electrodes 22 and the scan electrodes 26 as well as the oxide dielectric layer 28 formed thereon can be inserted into the recess 18 when the front substrate 20 and the rear substrate 10 are combined. When the front substrate 20 and the rear substrate 10 are sealed with each other with the above structure, crosstalk between the discharge cells 17 adjacent to each other along the second direction can be prevented (or reduced) without needing an extra dielectric layer along the first direction (the y-axis direction) crossing the oxide dielectric layer 28.

A height (H1) of the oxide dielectric layer 28 measured along a direction perpendicular to the front substrate 20 is equal (or substantially equal) to a height (H2) of the recess 18 formed on the first barrier rib 16a on the rear substrate 10. Due to the fact that the height (H1) of the oxide dielectric layer 28 is equal (or substantially equal) to the height (H2) of the recess 18, the sustain electrodes 25 and the scan electrodes 26 can be fitted into the recess 18 when the front substrate 20 and the rear substrate 10 are sealed against each other.

The height (H1) of the oxide dielectric layer 28 may be higher than the height (H2) of the recess. In this case, apertures for allowing the discharge cells adjacent to each other to communicate with each other along the second direction can be formed to improve the exhausting efficiency, and this also belongs to the scope of the present invention.

As described above, in the present embodiment, the oxide dielectric layer 28 is formed by the method of directly oxidizing the sustain electrodes 25 and the scan electrodes 26. The oxide dielectric layer 28 formed in this way has a relatively fine surface and a relatively high dielectric withstanding voltage. In addition, because there is no need to form an extra mask pattern on the electrodes when the dielectric layer is formed on the surface of the electrodes, the process of manufacturing the dielectric layer can be simplified.

Following are descriptions of methods for manufacturing a plasma display panel according to an embodiment of the present invention.

A method of manufacturing a plasma display panel according to the present embodiment includes forming electrodes between a pair of substrates, and forming an oxide dielectric layer, which is an oxide of materials for the electrodes, on the surface of the electrodes by anodizing the electrodes. The present embodiment may include forming barrier ribs for partitioning a plurality of discharge cells between the pair of substrates, forming recesses that communicate with one another along a second direction crossing a first direction on the barrier ribs on the boundaries of the discharge cells adjacent to each other along the first direction, and inserting the electrodes with the oxide dielectric layer on the surface thereof into the recesses.

The forming of electrodes between the pair of substrates and the forming of the recesses on the barrier ribs may be done by any suitable method. For example, the barrier ribs may be formed by sand blasting, and the recesses may be formed by suitable mechanical and/or chemical methods. The following descriptions are mainly concerned with forming sustain electrodes and scan electrodes on the front substrate, and forming an oxide dielectric layer on the surface of the sustain electrodes and the scan electrodes.

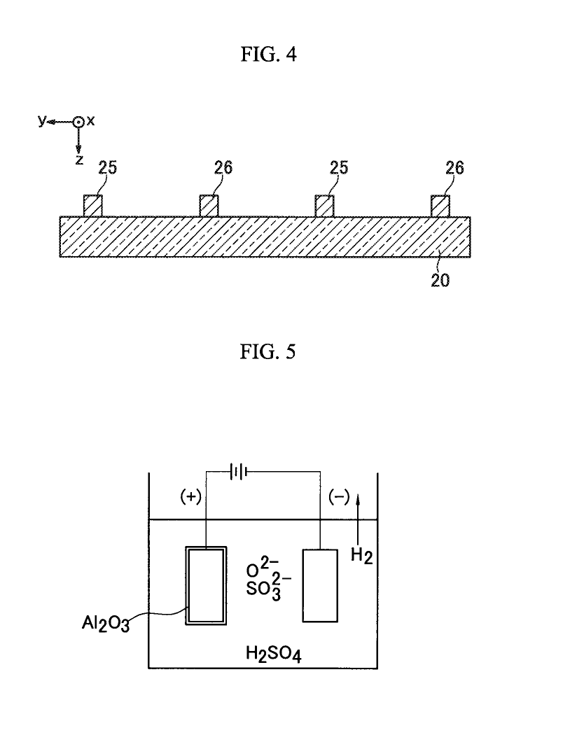

Referring to FIG. 4, the sustain electrodes 25 and the scan electrodes 26 that are made of aluminum (Al) are patterned on the front substrate 20. In FIG. 4, the address electrodes and the front dielectric layer are omitted for convenience of description, and the sustain electrodes 25 and the scan electrodes 26 that are formed on the front substrate 20 may be formed by various suitable methods including patterning.

After that, the sustain electrodes 25 and the scan electrodes 26 that are patterned are anodized, and the oxide dielectric layers are directly formed on the surface of the sustain electrodes 25 and the scan electrodes 26. The process of anodizing will be described in more detail below with reference to FIG. 5.

Referring to FIG. 5, when the formed sustain electrodes and scan electrodes are connected to the positive terminal of a battery and immersed in an electrolyte solution (H₂SO₄) in which a wire connected to the negative terminal of the battery is disposed, the surfaces of the sustain electrodes and scan electrodes are oxidized by oxygen generated by the electrical current and the aluminum oxide (Al₂O₃) layer is formed. The chemical formula for the above reaction can be represented as follows.

2Al+3H₂SO₄+16H₂O

[symbol]

Al₂(SO₄)₃.16H₂O+3H₂↑

[symbol]

Al₂O₃+3H₂SO₄+13H₂O Formula 1

By the above anodizing, the oxide layer can be formed on the surface of the sustain electrodes and scan electrodes by one process, so that the number of steps for forming dielectric layer can be dramatically reduced.

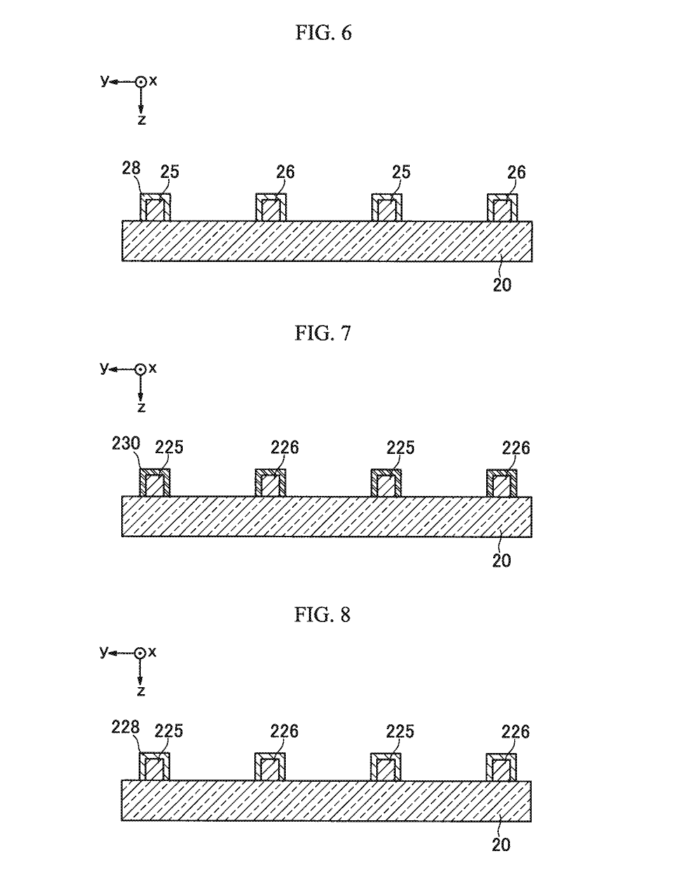

Referring to FIG. 6, the aluminum oxide (Al₂O₃) dielectric layer 28 that is formed on the surface of the sustain electrodes 25 and the scan electrodes 26 by anodizing is shown. As described above, the dielectric layer 28 that is made of aluminum oxide is directly formed on the surface of the sustain electrodes 25 and the scan electrodes 26, so a dielectric layer 28 having a relatively fine surface and a relatively high dielectric withstanding voltage can be easily formed.

In the present embodiment, the thickness of the aluminum oxide (Al₂O₃) dielectric layer 28 is about 50 μm, and it was shown by experiments that a dielectric layer 28 having a thickness of about 40 μm has a characteristic dielectric withstanding voltage of about 600V.

Followings are descriptions of the various embodiments of the present invention. The plasma display panel according to each embodiment has substantially the same structure and function as those of the first embodiment, so the detailed description thereof is omitted.

Referring to FIG. 7, sustain electrodes 225 and scan electrodes 226 that are formed on a front substrate 20 are patterned with a non-aluminous metal. For example, the sustain electrodes 225 and the scan electrodes 226 may be patterned with a metal selected from the group consisting of silver (Ag), copper (Cu), and gold (Au). In addition, the sustain electrodes 225 and the scan electrodes 226 are covered with an aluminum (Al) layer 230.

That is, in the embodiment of FIG. 6 (e.g., the first embodiment), the sustain electrodes and the scan electrodes are made of aluminum (Al), and the aluminum is directly oxidized to form an oxide dielectric layer on the surface of the sustain electrodes and the scan electrodes. In the embodiment of FIG. 7 (e.g., the second embodiment), however, the sustain electrodes 225 and the scan electrodes 226 are made of metals other than aluminum (Al), and an aluminum layer 230 is formed on the outer surface of the electrodes and then the aluminum layer 230 is anodized.

Referring to FIG. 8, the aluminum layer formed as in FIG. 7 is oxidized to be aluminum oxide by anodizing. In other words, the oxide dielectric layer 228 made of aluminum oxide (Al₂O₃) is formed on the surface of the sustain electrodes 225 and the scan electrodes 226. The oxide dielectric layer 228 formed in this way also has a relatively fine surface and a relatively high dielectric withstanding voltage.

As described above, in embodiments of the invention, by directly oxidizing sustain electrodes and scan electrodes through anodizing, or directly oxidizing an aluminum layer, that is formed on the surface of sustain electrodes and scan electrodes, through anodizing, an oxide dielectric layer having a relatively fine surface and a relatively high dielectric withstanding voltage can be formed.

In addition, by forming recesses on the barrier ribs formed on a rear substrate, dielectric layers formed along one direction through anodizing can be fitted into the recesses, and a display panel having an opposed discharge structure of a matrix can be easily manufactured.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a first substrate;
a second substrate facing the first substrate;
a plurality of first electrodes disposed along a first direction between the first substrate and the second substrate;
a plurality of second electrodes disposed apart from the first electrodes between the first substrate and the second substrate, and extending along a second direction crossing the first direction;
a plurality of third electrodes disposed apart from the first electrodes between the first substrate and the second substrate, and extending along the second direction; and
a plurality of oxide dielectric layers disposed on the first electrodes, the second electrodes, or the third electrodes, the oxide dielectric layers comprising oxidized materials of the first electrodes, the second electrodes, or the third electrodes.

2. The plasma display panel of claim 1, wherein the materials of the first electrodes, the second electrodes, or the third electrodes comprise aluminum, and wherein the oxide dielectric layers comprise aluminum oxide.

3. The plasma display panel of claim 1, wherein the second electrodes and the third electrodes protrude along a direction away from the second substrate and face each other with a space therebetween.

4. The plasma display panel of claim 3, further comprising a plurality of barrier ribs for defining a plurality of discharge cells between the first substrate and the second substrate,
wherein the second electrodes and the third electrodes are located on the boundaries of the discharge cells adjacent to each other along the first direction, and are arranged alternately along the first direction.

5. The plasma display panel of claim 3, further comprising a plurality of barrier ribs for defining a plurality of discharge cells between the first substrate and the second substrate,
wherein a plurality of recesses are disposed on the boundaries of the discharge cells adjacent to each other along the first direction,
wherein the recesses communicate with one another along the second direction, and
wherein the second electrodes and the third electrodes are inserted into the recesses.

6. The plasma display panel of claim 5, wherein the barrier ribs comprise:
a plurality of first barrier rib members extending along the first direction; and
a plurality of second barrier rib members extending along the second direction,
wherein the recesses are formed at intersections of the first barrier rib members and the second barrier rib members.

7. The plasma display panel of claim 5, wherein the barrier ribs comprise:
a plurality of first barrier rib members extending along the first direction; and
a plurality of second barrier rib members extending along the second direction,
wherein a height of the first barrier rib members measured along a direction perpendicular to the first substrate is higher than a height of the second barrier rib members.

8. The plasma display panel of claim 5, wherein the oxide dielectric layers extend along the second direction.

9. The plasma display panel of claim 8, wherein a width of the oxide dielectric layers measured along the first direction is not greater than a width of the recesses.

10. The plasma display panel of claim 9, wherein a height of the oxide dielectric layer measured along a direction perpendicular to the second substrate is substantially equal to a height of the recesses.

11. The plasma display panel of claim 1, wherein the first electrodes are disposed on the second substrate, and are located on boundaries of the discharge cells adjacent to each other along the second direction.

12. The plasma display panel of claim 1, wherein the first electrodes comprise a plurality of bus electrodes and a plurality of protrusion electrodes, and wherein the bus electrodes are located on boundaries of the discharge cells adjacent to each other along the second direction.

13. The plasma display panel of claim 11, wherein one of the protrusion electrodes corresponds to one of the discharge cells and protrudes from one of the bus electrodes toward the center of the one of the discharge cells.

14. A plasma display panel comprising:
a first substrate;
a second substrate facing the first substrate;
an address electrode disposed along a first direction between the first substrate and the second substrate;
a sustain electrode disposed apart from the address electrode between the first substrate and the second substrate, and extending along a second direction crossing the first direction;
a scan electrode disposed apart from the first electrodes between the first substrate and the second substrate, and extending along the second direction; and
an oxide dielectric layer disposed on the address electrode, the sustain electrode, or the scan electrode, the oxide dielectric layer comprising an oxidized material of the address electrode, the sustain electrode, or the scan electrode.

15. A method of manufacturing a plasma display panel, the method comprising:
forming a plurality of electrodes between a pair of substrates; and
anodizing the electrodes to form a plurality of oxide dielectric layers comprising oxides of materials of the electrodes on the electrodes.

16. The method of claim 15, wherein the forming of the electrodes comprises patterning aluminum to form the electrodes, and wherein the forming of the oxide dielectric layers comprises anodizing the aluminum to form the oxide dielectric layers comprising aluminum oxides.

17. The method of claim 15, wherein the forming of the electrodes comprises:
patterning a non-aluminous material to form the electrodes; and
covering the non-aluminous metal with aluminum.

18. The method of claim 17, wherein the forming of the oxide dielectric layers comprises anodizing the aluminum to form the oxide dielectric layers comprising aluminum oxides on a surface of the non-aluminous metal.

19. The method of claim 17, wherein the non-aluminous metal comprises silver, copper, or gold.

20. The method of claim 15, comprising:
forming barrier ribs for defining a plurality of discharge cells between the pair of substrates;
forming recesses on the barrier ribs, the recesses being boundaries of the discharge cells adjacent to each other along a first direction, the recesses communicating with one another along a second direction crossing the first direction; and
inserting the electrodes into the recesses, the electrodes having the oxide dielectric layers formed on surfaces thereof.
